(19) United States
(12) Patent Application Publication
(10) Pub. No.: US 2017/0183516 A1
(43) Pub. Date: Jun. 29, 2017

(54) METHOD FOR THE MANUFACTURE OF A FORMULATION AND FORMULATION

(71) Applicant: GUARNIFLON S.P.A., CASTELLI CALEPIO (IT)

(72) Inventors: MASSIMO VILLANO, CASTELLI CALEPIO (IT); GIACOMO SIMONI, CASTELLI CALEPIO (IT)

(21) Appl. No.: 15/391,914

(22) Filed: Dec. 28, 2016

(30) Foreign Application Priority Data
Dec. 28, 2015 (IT) 102015000087948

(51) Int. Cl. C09D 7/12; B22F 9/08; C09D 127/18; B22F 3/20; B22F 3/10; B29B 7/00; B22F 1/00

(52) U.S. Cl. CPC C09D 7/1291; B29B 7/00; B22F 9/082; B22F 1/0048; B22F 3/20; B22F 3/10; B22F 1/0014; C09D 127/18; B29K 2505/12

(57) ABSTRACT

Method for the manufacture of a formulation comprising the steps of: i) providing a metal in liquid form; ii) spraying the metal or metal alloy of step i) through a stream of gas under pressure to obtain substantially spherical solid metal particles; iii) mixing the solid metal particles of step ii) and at least a fluoropolymer to obtain said formulation; iv) optionally applying the formulation of step iii) to a surface to obtain a coating, or optionally shaping said formulation to obtain a shaped material.

The present invention further relates to a formulation, a coating or a shaped material, preferably obtained through the method described.

The present invention relates to a process for the manufacture of a formulation, a coating or a shaped material, and a formulation, a coating or a shaped material comprising a fluoropolymer.

Polytetrafluoroethylene (PTFE) is a tetrafluoroethylene polymer which has a number of desirable features both under the chemical and chemical-physical profile.

Merely by way of example, we may mention a high chemical inertia and resistance to heat, excellent dielectric features, excellent resistance to aging and a low coefficient of friction associated with self-lubricating properties.

However, there are some applications in which the features of PTFE need to be improved, in particular through the introduction of suitable fillers in the polymer, such as glass fibers, carbon, graphite, other polymers or mixtures thereof.

However, in special dynamic applications it has been found that the fillers currently used are not sufficiently well-performing, especially in cases where high resistance to compression and wear is required, along with an excellent surface finish.

The present invention falls within the above context, aiming to provide a coating or shaped material made of a fluoropolymer capable of ensuring a higher resistance to compression and wear than current materials, and while at the same time ensuring a more than satisfactory surface finish.

The object of the present invention will now be described with the help of the annexed drawings wherein:

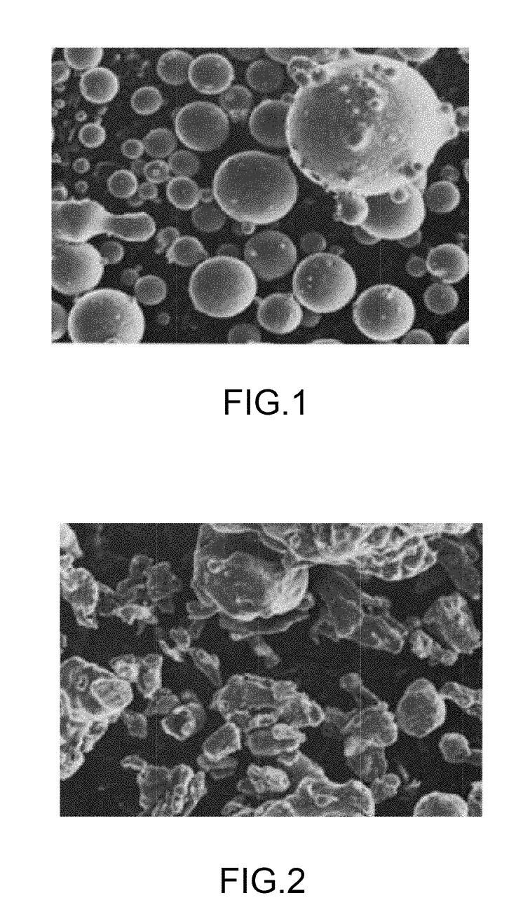

FIG. 1 shows a SEM micrograph (300x) of substantially spherical or ellipsoidal solid metal particles according to the present invention;

FIG. 2 shows a SEM micrograph (300x) of irregular solid metal particles that do not conform the present invention;

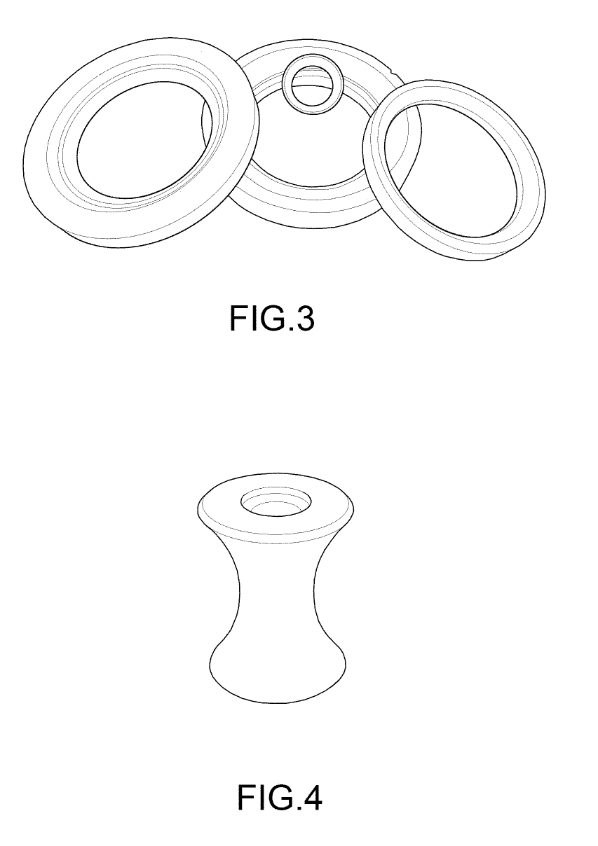

FIGS. 3 and 4 show possible semi-finished products or shaped materials obtainable according to the invention.

Said object is achieved by a method for the manufacture of a coating or of a shaped material comprising the steps of:

i) providing a metal or a metal alloy in liquid form;

ii) spraying the metal or metal alloy of step i) through a stream of gas under pressure to obtain substantially spherical or ellipsoidal solid metal particles;

iii) mixing the solid metal particles of step ii) and at least a fluoropolymer to obtain said formulation;

iv) optionally applying the formulation of step iii) to a surface to obtain said coating, or optionally shaping the formulation to obtain the shaped material.

According to an embodiment, the gas in step ii) comprises or consists of an inert gas, purely by way of example nitrogen.

Preferably, the gas in step ii) is used at a pressure equal to or higher than about 1.5 MPa (for example in the range 2-4 MPa).

As regards step iii), a variant contemplates that such a step comprises at least one dry mixing of the fluoropolymer and of the solid metal particles.

Preferably, in the formulation, in the coating or in the shaped material, the fluoropolymer acts as a matrix for the solid metal particles.

At least part of these particles is therefore preferably incorporated within the fluoropolymer.

According to a first embodiment, the metal or metal alloy of step i) comprises or consists of iron or more preferably stainless steel, for example AISI 316 L steel.

According to a second embodiment, the fluoropolymer comprises or consists of polytetrafluoroethylene (PTFE), such as virgin PTFE.

According to a preferred embodiment, the fluoropolymer is present in the formulation in granular form.

According to further embodiments, the fluoropolymer may be in the form of homo-polymer of tetrafluoroethylene (TFE), or in the form of a copolymer comprising TFE monomer and one or more further fluorinated monomers, preferably in a quantity equal to or less than 2% by weight with respect to the total weight of TFE.

It is noted that, unless otherwise specified, the percentages given in this description are percentages by weight (% wt).

Advantageously, in the formulation of step iii), the fluoropolymer is present in a percentage by weight of at least 30% wt, preferably in a percentage equal to or greater than 40% wt, for example in the range 30-99% wt or 30-80% wt.

According to a preferred variant, the solid metal particles of the formulation have an average diameter in the range of 5-120 μm, preferably 5-50 μm, for example 10-25 μm.

It is noted that, in the formulation object of the present invention, further fillers may also be present in addition to the solid metal particles described above, of organic and/or inorganic type, mixed in such a formulation.

Merely by way of example we may mention silica (glass), carbon, reinforcing fibers or particles, carbon fibers or particles, MoS2, calcium ionosilicate optionally of mineral nature (Wollastonite), titanium dioxide, alumina, barium sulfate, graphite, colouring pigments, poly-imide, cyclic polyesters (for example EKONOL®), polyether ether ketone (for example PEEK®), polyparaphenylene sulfide (PPS), polypropylene sulfone (PPSO2) or mixtures thereof.

According to other embodiments, step iv) comprises:

a) at least one pre-forming step of the formulation of step iii), and at least one subsequent sintering step of the pre-formed mixture; or

b) at least one extrusion step, a sintering step and/or at least one moulding step of the formulation of step iii);

in order to obtain said material.

According to further embodiments, step iv) may comprise at least one turning step to obtain the shaped material.

Merely by way of example, an automatic cam type lathe or a lathe with CNC control may be used to carry out the turning step.

The present invention further relates to a formulation, a coating or a shaped material.

Since a preferred embodiment provides that such a formulation/coating/material is obtained through the method just described, such a formulation/coating/material may include all the features that can be deduced—even implicitly—from the foregoing description.

Such a formulation, coating or shaped material comprises a mixture of spherical or ellipsoidal solid metal particles, consisting of a metal or a metal alloy, and at least a fluoropolymer.

According to a variant, the metal or metal alloy comprises or consists of iron or more preferably stainless steel, for example AISI 316 L steel.

According to an advantageous variant, the fluoropolymer comprises or consists of polytetrafluoroethylene (PTFE), for example in the form of homo-polymer or co-polymer as discussed above.

According to an embodiment, the fluoropolymer is present at least in a percentage by weight of 30% wt.

Preferably, such a percentage of fluoropolymer is equal to or greater than 40% wt, for example in the range 30-99% wt or 30-80% wt.

According to a further embodiment, the solid metal particles have an average diameter in the range of 5-120 μm, preferably 5-50 μm, for example 10-25 μm.

Advantageously, the present coating/material is characterised by an average density in the range 2.18-4.74 g/cm3, for example between 2.8-3.1 g/cm3.

As regards the application field object of the present invention, the coating or shaped material may constitute at least part of a friction bearing, friction shoe or pad, of a segment for a dry or lubricated compressor, a spherical bushing, a pivot support, a guide, a joint, of a seat or sealing element of a valve, preferably for an industrial machine and/or a valve.

For example, such a machine may be numerical control or a high-precision machine tool.

Advantageously, the valve may be a ball or a gate valve.

The object of the present invention will now be described on the basis of some non-limiting examples thereof.

### EXAMPLE 1: PREPARATION OF THE SAMPLES TO BE COMPARED

Three separate samples of the formulation according to the invention are prepared by dry mixing 50% wt of virgin PTFE and 50% wt of the solid metal particles indicated hereinafter:

1) Steel 316L; Standard D90=45 μm; spraying in water;

particles with irregular shape;

2) Steel 316L; Standard D90=45 μm; spraying in gas;

particles of spherical shape;

3) Steel 316L; Standard D90=22 μm; spraying in gas;

particles of spherical shape.

Samples 2) and 3) therefore fall within the scope of the present invention, while sample 1) with irregularly shaped particles is a comparison sample.

To this end, see the SEM micrographs (300x) of the solid metal particles 3) in FIG. 1, and of the solid metal particles 1) in FIG. 2 to see the non-conformity of the respective particles.

The semi-finished products indicated hereinafter are formed from the samples thus constituted. For convenience, the samples marked with references 1), 2), 3) hereinafter will correspond to particles 1)-3) contained therein.

It is noted that the semi-finished products of the examples constitute specific examples of shaped materials obtainable according to the present invention.

### EXAMPLE 2: ANALYSIS OF THE SAMPLES OF EXAMPLE 1

From the intermediate mixtures manufactured with particles 1), 2), 3), six semi-finished products were prepared in a round shape (diameter=60 mm; height=80 mm), two for each type, by means of a forming process comprising a pre-forming step and a sintering step.

Of these semi-finished products, one for each type of steel was “peeled” in film form (i.e. peeled to obtain a film) to a thickness of 0.6 mm for the mechanical characterization of the sample, the other was subjected to a roughness test.

The analyses performed on each type of sample are summarised in the following table:

A. Visual analysis
B. Gravimetric analysis
(density)
C. Mechanical analyses
D. Roughness measurements
E. Particle size analysis
F. Mechanical analyses
G. Hardness analysis
H. Wear tests

2.A. Visual analysis.

| Sample | Visual analysis results |
|---|---|
| 1) | Standard colour |
| 2) | Colour identical to the standard; |
| | Oxidation slightly deeper than the standard; |
| | To the touch, the film is slightly smoother |
| | than the standard; |
| 3) | Darker colour than the standard; |
| | Darker oxidation: on the one end, it has the |
| | same depth, on the other it has a very |
| | different colour, almost brown; |
| | To the touch, the film is very smooth. |

2.B. Gravimetric Analysis (Density)

A hydrostatic balance is used for measuring the density of the semi-finished products obtained. The data reported in the following table are comparable in absolute terms.

| | Density (g/cm3) |
|---|---|
| Sample | ASTM D792 |
| 1) | 3.292 |
| 2) | 3.333 |
| 3) | 3.358 |

2.C. Mechanical Analyses

The semi-finished products were prepared in the form of specimen in accordance with the ASTM D4745 standard. The measurements were made using a dynamometer INSTRON 3365.

| | Tensile strength | Elongation breaking |
|---|---|---|
| Sample | ASTM D4745 (N/mm2) | ASTM D4745 (%) |
| 1) | 18.72 | 166.14 |
| 2) | 18.48 | 204.27 |
| 3) | 23.84 | 242.66 |

From the above table it can be seen that the mechanical features of sample 3) are markedly better than those of sample 1), while those of sample 2) are comparable to those of sample 1) with the exception of an improvement in elongation breaking.

2.D. Roughness Measurement

A semi-finished product was processed in the form shown in FIG. 3 through mechanical machining, to then be subjected to a first roughness tests, the result of which is shown in the following table as “value 1”. FIG. 4 shows other possible semi-finished products or shaped materials obtainable according to the invention, for example of annular shape. These semi-finished products may preferably be or comprise seals or gaskets.

For a more accurate measurement of roughness, such semi-finished product processed was then dissected to allow the execution of a more accurate measurement of roughness in the central area of the semi-finished product, indicated as “value 2” in the following table:

| | Roughness - Value 1 | Roughness - Value 2 |
|---|---|---|
| Sample | (Ra) | (Ra) |
| 1) | 4.8 | — |
| 2) | 3.6 | 3.378 |
| 3) | 1.6 | 1.798 |

The roughness table shows that the roughness of samples 2) and 3) is markedly lower than that of sample 1).

2.E. Particle Size Analysis

In the following table, column “d100” indicates the maximum particle size for the various samples.

| Sample | d50 | d90 | d100 |
|---|---|---|---|
| 1) | 34.65 μm | 58.81 μm | ≈95 μm |
| 2) | 43.36 μm | 71.51 μm | ≈107 μm |
| 3) | 10.25 μm | 26.96 μm | ≈55 μm |

From the analyses above, it can be seen that sample 3) has a tighter particle size distribution and therefore more homogeneous with respect to samples 1) and 2).

The smaller particle size of sample 2) and its greater homogeneity involve a better volumetric distribution within the formulation, being arranged in a homogeneous manner within the PTFE matrix.

2.F. Porosity Analysis

| | | | | Total | | | |
|---|---|---|---|---|---|---|---|
| | | | Total | pore | Median | | |
| | Bulk | Apparent | pore | surface | pore | Accessible | Inaccessible |
| | Density | Density | volume | area | radius | Porosity | Porosity |
| Sample | (g/cm3) | (g/cm3) | (mm3/g) | (m2/g) | (μm) | (%) | (%) |
| 1) | 3.1354 | 3.3471 | 20.16 | 3.279 | 0.0182 | 6.62 | 2.87 |
| 2) | 3.2412 | 3.4429 | 18.08 | 2.944 | 0.0172 | 5.86 | 0.81 |
| 3) | 3.2582 | 3.4526 | 17.29 | 2.937 | 0.0164 | 5.63 | 0.01 |

A helium pycnometer and a mercury porosimeter were used this analysis, and the porosimetry of samples/semi-finished products 1), 2) and 3) was evaluated.

From the table above it is deduced that sample 1) has a porosity and a pore size greater than samples 2) and 3). Therefore, it can be assumed that samples 2) and 3) are likely to have a greater resistance to compression and better sealing properties to liquids and to gases compared to the control sample 1).

2.G. Shore D Hardness and Rockwell Hardness Analysis

| | Shore D | Rockwell |
|---|---|---|
| Sample | hardness | Hardness (MPa) |
| 1) | 63 | 39 |
| 3) | 63 | 38 |

The hardness values obtained on samples 1) and 3) are substantially matching.

2.H. Wear Tests

| | | | | | | | | | Wear | | |
|---|---|---|---|---|---|---|---|---|---|---|---|
| | Friction | | | | Temperature | | | | Last | p * v | K |
| | | | | Average | | | | Average | reading | (N/mm² * | (mm²/N * |
| Sample | Final @ | Max | Min | (KKS) | Final @ | Max | Min | (RMB) | (mm) | m/h) | m) |
| 1) | 0.046 | 0.500 | 0.044 | 0.215 | 92.0 | 169.2 | 59.4 | 95.8 | 1.01651 | 3.793,6 | 2.93444E−06 |
| (Load 2 kg - | | | | | | | | | | | |
| Speed | | | | | | | | | | | |
| 4 m/s) | | | | | | | | | | | |
| 3) | 0.232 | 0.462 | 0.150 | 0.306 | 106.1 | 175 | 54.7 | 132 | 1.01625 | 2.793,6 | 2.71476E−06 |
| (Load 2 kg - | | | | | | | | | | | |
| Speed | | | | | | | | | | | |
| 4 m/s) | | | | | | | | | | | |
| 1) | 0.179 | 0.518 | 0.144 | 0.231 | 56.9 | 96.8 | 56.1 | 65.6 | 1.01625 | 1.164,2 | 5.29022E−06 |
| (Load 2 kg - | | | | | | | | | | | |
| Speed | | | | | | | | | | | |
| 2 m/s) | | | | | | | | | | | |
| 3) | 0.294 | 0.381 | 0.192 | 0.284 | 58.9 | 80.5 | 41.5 | 66.2 | 0.68584 | 1.164,2 | 3.52747E−06 |
| (Load 2 kg - | | | | | | | | | | | |
| Speed | | | | | | | | | | | |
| 2 m/s) | | | | | | | | | | | |

Wear tests were conducted using a tribometer on samples/semi-finished products 1) and 3) in accordance with the ASTM D3702 standard, according to a “pin on disc” procedure.

The wear tests carried would lead to deduce that, at low loads, the spherical sample 3) has a better wear behaviour than sample 1), more evident at lower speed values, this aspect probably due to the spherical nature of the fillers used.

Innovatively, the method object of the present invention allows obtaining higher performance fluoropolymers compared to known fluoropolymers by providing, among other things, surface finishes with a low roughness value, while preventing the need for surface post-treatments to improve such a feature.

Innovatively, the formulation, the coating or the shaped material object of the present invention has a combination of highly desirable features, in particular high compression strength, high resistance to chemical agents and the substantial absence of electrostatic charges.

Advantageously, the formulation, the method and the coating/material object of the present invention allow increasing the wear resistance and reducing the overall coefficient of thermal expansion, at least compared to a conventional fluoropolymer, without the fillers object of the invention.

Advantageously, the formulation object of the present invention allows obtaining a good workability in the steps downstream of its obtaining, by producing surface finishes with an extremely low roughness as a result of mechanical machining performed with traditional parameters.

Advantageously, the formulation, the method and the coating/material object of the present invention allow the production of products with a very low porosity, thereby improving the liquid and gas sealing properties thereof.

A man skilled in the art may make several changes or replacements of elements with other functionally equivalent ones to the embodiments of the formulation, of the method and of the coating/material in order to meet specific needs.

Also such variants are included within the scope of protection as defined by the following claims.

Moreover, each variant described as belonging to a possible embodiment may be implemented independently of the other variants described.

1. Method for the manufacture of a formulation, of a coating or of a shaped material comprising the steps of:
i) providing a metal or a metal alloy in liquid form;
ii) spraying the metal or metal alloy of step i) through a stream of gas under pressure to obtain substantially spherical or ellipsoidal solid metal particles;
iii) mixing the solid metal particles from the previous step ii) and at least a fluoropolymer to obtain said formulation;
iv) optionally applying the formulation of step iii) to a surface to obtain said coating, or optionally shaping said formulation to obtain said shaped material.

2. Method according to claim 1, wherein the gas of step ii) comprises or consists of an inert gas, used at a pressure equal to or greater than about 1.5 MPa.

3. Method according to claim 1 or 2, where step iii) comprises at least one dry mixing of the fluoropolymer and of the solid metal particles.

4. Method according to any of the preceding claims, wherein, in the formulation of step iii), the fluoropolymer is present at least in a percentage by weight of 30% wt, preferably in a percentage equal to or greater than 40% wt, for example in the range 30-99% wt.

5. Method according to any of the previous claims, wherein step iv) comprises:
a) at least one pre-forming step of the formulation of step iii), and at least one subsequent sintering step of the pre-formed formulation; or
b) at least one extrusion step, a sintering step and/or at least one moulding step of the formulation of step iii);
in order to obtain said material.

6. Method according to any of the preceding claims, wherein the solid metal particles obtained in step ii) have an average diameter in the range of 5-120 μm, preferably 5-50 μm, for example 10-25 μm.

7. Method according to any of the preceding claims, wherein the metal or metal alloy of step i) comprises or consists of stainless steel, for example AISI 316 L steel.

8. Method according to any of the preceding claims, wherein the fluoropolymer comprises or consists of polytetrafluoroethylene (PTFE), for example homo-polymer or co-polymer.

9. Formulation, coating or shaped material comprising a mixture of spherical or ellipsoidal solid metal particles, consisting of a metal or a metal alloy, and at least a fluoropolymer.

10. Formulation, coating or shaped material according to the preceding claim, wherein the fluoropolymer is present at least in a percentage by weight of 30% wt, preferably in a percentage equal to or greater than 40% wt, for example in the range 30-99% wt.

11. Formulation, coating or shaped material according to any of the claims 9-10, wherein the solid metal particles have an average diameter in the range of 5-120 μm, preferably 5-50 μm, for example 10-25 microns.

12. Formulation, coating or shaped material according to any of the claims 9-11, characterised by an average density in the range 2.18-4.74 g/cm3, for example between 2.8-3.1 g/cm3.

13. Formulation, coating or shaped material according to any of the claims 9-12, wherein the metal or metal alloy comprises or consists of stainless steel, for example AISI 316 L steel.

14. Formulation, coating or shaped material according to any of the claims 9-13, wherein the fluoropolymer comprises or consists of polytetrafluoroethylene (PTFE), for example homo-polymer or co-polymer.

15. Formulation, coating or shaped material according to any of the claims 9-14, comprising further charges additional to said solid metal particles mixed in said formulation/coating/shaped material, said charges being of the organic and/or inorganic type and being selected from the group consisting of silica, charcoal, reinforcement particles or fibres, carbon particles or fibres, MoS2, calcium inosilicate optionally of a mineral nature, titanium dioxide, alumina, barium sulphate, graphite, colouring pigments, polyimide, cyclic polyesters, ether ketone polyether, polyparaphenylene sulfide, polypropylene sulfone or mixtures thereof.

16. Formulation, coating or shaped material according to any of the claims 9-15, characterised in that it constitutes at least part of a friction bearing, friction shoe or pad, of a segment for a dry or lubricated compressor, a spherical bushing, a pivot support, a guide or a joint, of a seat or sealing element of a valve, for example for an industrial machine and/or a valve.
